(19) United States
(12) Patent Application Publication
(10) Pub. No.: US 2026/0085945 A1
(43) Pub. Date: Mar. 26, 2026

(54) SYSTEMS AND METHODS FOR UPDATING MAP DATABASE BY PROCESSING OBSERVATIONS

(71) Applicant: HERE Global B.V., Eindhoven (NL)

(72) Inventor: Dennis Scott WILLIAMSON, Wheaton, IL (US)

(21) Appl. No.: 18/896,437

(22) Filed: Sep. 25, 2024

(51) Int. Cl. G01C 21/00

(52) U.S. Cl. CPC G01C 21/3807; G01C 21/3833

(57) ABSTRACT

A system for updating a map database obtains observation data associated with each observation of a plurality of observations. The plurality of observations is associated with an object. The system further obtains ground truth data associated with the object and classifies each observation of the plurality of observations as one observation feature of a plurality of observation features based on the obtained observation data and the obtained ground truth data. Furthermore, the system determines a generalized probability distribution for the plurality of observations based on the classification of each observation of the plurality of observations and determines a confidence score based on the generalized probability distribution. Furthermore, the system determines updated status data for the object based on the ground truth data and the confidence score and updates the map database based on the updated status data.

### TECHNOLOGICAL FIELD

The present disclosure generally relates to routing and navigation systems, and more particularly relates to systems and methods for updating a map database by processing object observations.

### BACKGROUND

There are currently various navigation systems available to provide navigation assistance. These systems typically request navigation-related data or map data from a navigation service, such data being associated with one or more routes. Since road conditions and objects on roads or links change dynamically and rapidly, the accuracy of the map data used is crucial for effective navigation assistance, especially in the context of autonomous vehicle control, semi-autonomous vehicle control, and route management for service robots, automated appliances, etc. It is essential that the map data accurately represents real-world environments.

However, features related to navigation, such as objects along designated routes, may change over time due to factors such as the construction of new routes. Sensor data plays a crucial role in keeping map data up-to-date in addressing this challenge. However, in many scenarios, sensor data may lack accuracy. For instance, due to factors such as sensor limitations, occlusions or lack of inference capabilities, some sensor data may lead to false positives by mischaracterization of non-road signs as object observations, or false negatives by failing to capture accurate sensor data of the objects due to adverse weather conditions or occlusion caused by other vehicles.

As a result, there is a need for systems and methodologies that can efficiently and reliably update map data to ensure its alignment with real-world environments.

### BRIEF SUMMARY OF SOME EXAMPLE EMBODIMENTS

It is an objective of some embodiments of the present disclosure to efficiently update map data such that the updated map data corresponds to a ‘true’ or ‘near true’ reflection of real-world environments. To this end, some embodiments are directed towards updating the map data using sensor data. In various embodiments, the sensor data may be associated with one or more road objects or one or more landmarks. As used herein, the one or more road objects may correspond to road obstacles, traffic objects, posted signs (e.g., road signs), lane markings, road edges, and/or the like. As used herein, the one or more landmarks may correspond to physical objects, Point of Interest (POIs), celestial objects, and/or the like. The physical objects may include statues, buildings, walls, trees, and/or the like. Usually, these physical objects may be notable objects detected by various autonomous service robots such as delivery robots, pet robots, and/or industrial robots. Additionally, or alternatively, the physical objects may be notable objects detected by automated appliances such as lawnmowers, vacuum cleaners, etc. The POIs may include restaurants, gas stations, museums, shopping malls, hospitals, and/or the like. The celestial objects may include stars, comets, and/or the like. Hereinafter, the term “object(s)” may be used to refer to any physical body that exists within an environment of a sensor device capable of providing observations associated with such a physical body. Without limitation, such objects may include “road object(s)” and/or “landmark(s)”. As used herein, observation data or observation associated with an object may correspond to raw or processed sensor data corresponding to the object.

Various embodiments are provided to derive, from the sensor data, observation data associated with a plurality of observations of the one or more objects. In some embodiments, the observation data may include object type information of the one or more objects, location information of the one or more objects, identity information (such as map ID) of the one or more objects, and/or the like. Various embodiments are provided to classify each observation of the plurality of observations as one of a plurality of observation features. In various embodiments, the plurality of observation features may include two or more of a true positive observation feature, a false positive observation feature, a true negative observation feature, or a false negative observation feature. In some embodiments, the classification of the plurality of observations may be based on the observation data and ground truth data associated with the one or more objects. In various embodiments, the ground truth data may indicate one of a presence of the one or more objects in the map data, or an absence of the one or more objects in the map data.

Various embodiments are provided to determine a generalized probability distribution for the plurality of observations based on the classification of the plurality of observations. In various embodiments, the generalized probability distribution may include a set of probability values for a set of observation features of the plurality of observation features. Various embodiments are provided to determine a confidence score for the plurality of observations based on the generalized probability distribution. In various embodiments, the confidence score may correspond to a maximum probability value of the set of probability values included in the generalized probability distribution. Various embodiments are provided to update the map data based on the confidence score. In various embodiments, the updated map data may be utilized to provide one or more navigation functions such as providing vehicle speed guidance, vehicle speed handling and/or control, providing a route for navigation (e.g., via a user interface), localization, route determination, lane level speed determination, operating the vehicle along a lane level route, lane maintenance, route guidance, provision of traffic information/data, provision of lane level traffic information/data, vehicle trajectory determination and/or guidance, route and/or maneuver visualization, and/or the like.

Thus, some example embodiments of the disclosure provide techniques for validating and improving map databases. Enabled with such an improved and updated map database, cnd use devices and systems such as navigation systems that utilize the map database for generating routing instructions benefit from the improved accuracy and are thus capable of generating accurate navigation and/or control instructions. In this way, embodiments of the present disclosure provide measures and techniques to mitigate inaccuracies of navigation systems, thereby reducing potentially dangerous maneuvers that could otherwise lead to accidents or collisions of the vehicles utilizing the map data of the map database. These and several other improvements and real-world applications would become apparent to one of ordinary skill in the art with the aid of the various example embodiments provided in this disclosure. Accordingly, to achieve the aforementioned objectives and advantages, some embodiments provide systems, methods, and computer program products for updating a map database using sensory observations provided by data gatherers such as vehicles, mobile devices, and/or roadside units.

In one aspect, a system for updating a map database is disclosed. The system may comprise a memory configured to store computer-executable instructions, and a processor configured to execute the computer-executable instructions. In this regard, the processor may obtain observation data associated with each observation of a plurality of observations. The plurality of observations are associated with an object. The processor may further obtain ground truth data associated with the road object, where the ground truth data indicates one of a presence of the object in map data of a map database, or an absence of the object in map data of the map database. Furthermore, the processor may classify each observation of the plurality of observations as one observation feature of a plurality of observation features, based on the observation data of a corresponding observation of the plurality of observations and the ground truth data. Furthermore, the processor may determine a generalized probability distribution for the plurality of observations, based on the classification of each observation of the plurality of observations. The generalized probability distribution includes a set of probability values for a set of observation features of the plurality of observation features. Furthermore, the processor may determine a confidence score for the plurality of observations based on the generalized probability distribution and determine updated status data of the object based on the ground truth data and the confidence score. Furthermore, the processor may update the map database based on the updated status data of the object.

In additional system embodiments, in order to classify each observation of the plurality of observations, the processor may compare the observation data associated with each observation of the plurality of observations with the ground truth data to obtain a corresponding result. Further, the processor may generate, based on the corresponding result, a classification matrix for each corresponding observation of the plurality of observations, where each element of the classification matrix corresponds to an observation feature of the plurality of observation features.

In additional system embodiments, in order to determine the generalized probability distribution, the processor may determine an individual probability distribution for each observation of the plurality of observations based on the classification matrix of a corresponding observation of the plurality of observations. Further, the processor may generate the generalized probability distribution based on the individual probability distribution of each observation of the plurality of observations.

In additional system embodiments, the classification matrix of a first observation of the plurality of observations includes a first column corresponding to a set of positive observation features of the plurality of observation features and a second column corresponding to a set of negative observation features of the plurality of observation features. In order to determine the individual probability distribution for the first observation, the processor may normalize the classification matrix of the first observation to obtain a normalized classification matrix and generate the individual probability distribution of the first observation based on one of the first column of the normalized classification matrix or the second column of the normalized classification matrix. The set of observation features corresponds to one of the set of positive observation features or the set of negative observation features.

In additional system embodiments, the set of positive observation features includes at least one of a true positive observation feature or a false positive observation feature and the set of negative observation features includes at least one of a true negative observation feature or a false negative observation feature.

In additional system embodiments, when the plurality of observations corresponds to a pair of observations, the processor may determine a Hadamard product of the individual probability distribution of each observation of the plurality of observations and determine a dot product of the individual probability distribution of each observation of the plurality of observations. Further, the processor may generate the generalized probability distribution based on the Hadamard product and the dot product.

In additional system embodiments, in order to generate the generalized probability distribution, the processor may determine a Hadamard product of the individual probability distribution of each observation of the plurality of observations and generate the generalized probability distribution based on an all-ones column matrix and the determined Hadamard product by dividing each element of the Hadamard product vector by the sum of all elements in the Hadamard product vector.

In additional system embodiments, the plurality of observations includes a first observation associated with a first-time instance and a second observation associated with a second-time instance subsequent to the first-time instance. In order to generate the classification matrix for each observation of the plurality of observations, the processor may generate a first classification matrix for the first observation, based on the corresponding result of the first observation and generate a second classification matrix for the second observation based on the corresponding result of the first observation and the corresponding result of the second observation.

In additional system embodiments, the confidence score corresponds to a maximum probability value among the set of probability values.

In additional system embodiments, the observation data associated with a first observation of the plurality of observations includes at least one of: object type information of the object, location information of the object, identity information of the object, time-stamp data of the first observation, or metadata associated with the first observation.

In additional system embodiments, the metadata associated with the first observation includes at least one of environmental data associated with the first observation or occlusion data associated with the first observation. The processor may classify the first observation as a first observation feature of the plurality of observation features, based on the metadata associated with the first observation.

In another aspect, a computer-implemented method for updating a map database is provided. The method may include obtaining observation data associated with each observation of a plurality of observations associated with an object and obtaining ground truth data associated with the object, where the ground truth data indicates one of a presence of the object in map data of the map database, or an absence of the object in map data of the map database. The method may further include classifying each observation of the plurality of observations as one observation feature of a plurality of observation features based on the observation data of a corresponding observation of the plurality of observations and the ground truth data and determining a generalized probability distribution for the plurality of observations based on the classification of each observation of the plurality of observations, where the generalized probability distribution includes a set of probability values for a set of observation features of the plurality of observation features. Furthermore, the method may include determining a confidence score for the plurality of observations, based on the generalized probability distribution, determining updated status data of the object based on the ground truth data and the confidence score, and updating the map database based on the updated status data of the object.

In yet another aspect, a computer program product is provided. The computer program product comprises at least one non-transitory computer-readable storage medium having stored thereon computer-executable instructions which when executed by a computer, cause the computer to carry out operations for updating a map database. The operations may include obtaining observation data associated with each observation of a plurality of observations associated with an object and obtaining ground truth data associated with the object, where the ground truth data indicates one of a presence of the object in map data of the map database, or an absence of the object in map data of the map database. The operations may further include classifying each observation of the plurality of observations as one observation feature of a plurality of observation features based on the observation data of a corresponding observation of the plurality of observations and the ground truth data and determining a generalized probability distribution for the plurality of observations based on the classification of each observation of the plurality of observations, where the generalized probability distribution includes a set of probability values for a set of observation features of the plurality of observation features. Furthermore, the operations may include determining a confidence score for the plurality of observations, based on the generalized probability distribution, determining updated status data of the object based on the ground truth data and the confidence score, and updating the map database based on the updated status data of the object.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described example embodiments of the invention in general terms, reference will now be made to the accompanying drawings, which are not necessarily drawn to scale, and wherein:

FIG. 1 illustrates a block diagram showing a network environment of a system for updating a map database, in accordance with one or more example embodiments;

FIG. 2 illustrates a block diagram showing the system for updating the map database by processing observations, in accordance with one or more example embodiments;

FIG. 3A illustrates a block diagram showing an exemplary format of map data stored in the map database, in accordance with one or more example embodiments;

FIG. 3B illustrates a block diagram showing another format of the map data stored in the map database, in accordance with one or more example embodiments;

FIG. 3C illustrates a block diagram showing yet another format of the map data stored in the map database, in accordance with one or more example embodiments;

FIG. 4 illustrates an exemplary working environment of the system for updating the map database, in accordance with one or more example embodiments;

FIG. 5A illustrates a block diagram showing an update process framework for updating the map database, in accordance with one or more example embodiments;

FIG. 5B illustrates a flowchart showing a process for classifying the plurality of observations, in accordance with one or more example embodiments;

FIG. 5C illustrates a conceptual diagram showing a classification matrix, in accordance with one or more example embodiments;

FIG. 5D illustrates a flowchart showing a process for determining a generalized probability distribution for the plurality of observations, in accordance with one or more example embodiments;

FIG. 6 illustrates a conceptual diagram showing a working environment of the system for updating the map data, in accordance with one or more example embodiments; and

FIG. 7 illustrates a flowchart showing a method for updating the map database, in accordance with one or more example embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses, systems, and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (for example, volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

A system, a method, and a computer program product are provided for updating a map database from sensor data. Specifically, the disclosed systems and methods aim to update map data of the map database by incorporating updated status data pertaining to one or more objects. When such updated map data is utilized for navigation assistance, it provides precise, accurate, and nearly true representations of the objects situated along designated routes. Essentially, the map data is characterized by its richness and comprehensive information content, ensuring high accuracy. Thus, the exemplary embodiments disclosed herein introduce substantial advancements to the mapping and navigation technology domain.

Furthermore, these embodiments eliminate the necessity for separate data acquisition processes beyond the routine observations made by data gathering devices such as the vehicle sensors, road side units or mobile devices. This streamlined approach reduces the complexity of the updating procedure and alleviates the associated processing burdens. The ensuing systems and methods that achieve these objectives will be elucidated herein, aided by various figures for clarity.

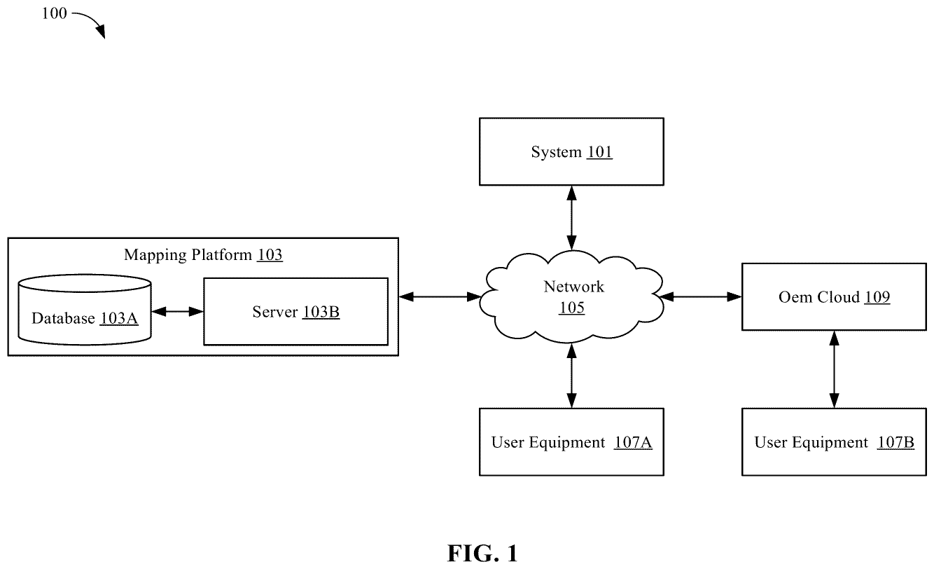

FIG. 1 illustrates a block diagram showing a network environment 100 of a system 101 for updating a map database 103a, in accordance with one or more example embodiments. The system 101 may be communicatively coupled, via a network 105, to one or more of a mapping platform 103, a user equipment 107a, and/or an OEM (Original Equipment Manufacturer) cloud 109. The OEM cloud 109 may be communicatively coupled to the user equipment 107b. The components described in the network environment 100 may be further broken down into more than one component such as one or more sensors or application in user equipment (such as the user equipment 107a and/or 107b) and/or combined together in any suitable arrangement. Further, it is possible that one or more components may be rearranged, changed, added, and/or removed without deviating from the scope of the present disclosure.

In an example embodiment, the system 101 may be embodied in one or more of several ways as per the required implementation. For example, the system 101 may be embodied as a cloud-based service, a cloud-based application, a cloud-based platform, a remote server-based service, a remote server-based application, a remote server-based platform, or a virtual computing system. As such, the system 101 may be configured to operate inside the mapping platform 103 and/or inside at least one of the user equipment 107a and the user equipment 107b.

In some embodiments, the system 101 may be embodied within one or both of the user equipment 107a and the user equipment 107b, for example as a part of an in-vehicle navigation system, a navigation app in a mobile device and the like. In each of such embodiments, the system 101 may be communicatively coupled to the components shown in FIG. 1 to carry out the desired operations and wherever required modifications may be possible within the scope of the present disclosure. The system 101 may be implemented in a vehicle, where the vehicle may be an autonomous vehicle, a semi-autonomous vehicle, or a manually driven vehicle. In an embodiment, the system 101 may be deployed in a consumer vehicle or a probe vehicle, and/or a ground truth collection vehicle to collect sensor data specifically for creating observations associated with one or more objects. The one or more objects may correspond to one or more road objects or one or more landmarks. As used herein, the one or more road objects may correspond to road obstacles, traffic objects, posted signs (e.g., road signs), lane markings, road edges, and/or the like. As used herein, the one or more landmarks may correspond to physical objects, celestial objects, and/or POIs. The physical objects may include statues, buildings, walls, trees, and/or the like. Usually, these physical objects may be notable objects detected by various autonomous service robots such as delivery robots, pet robots, and/or industrial robots. Additionally, or alternatively, the physical objects may be notable objects detected by automated appliances such as lawnmowers, vacuum cleaners, etc. The POIs may include restaurants, gas stations, museums, shopping malls, hospitals, and/or the like. The celestial objects may include stars, comets, and/or the like. Hereinafter, the term “object(s)” may be used to refer to any physical body that exists within an environment of a sensor device capable of providing observations associated with such a physical body. Without limitation, such objects may include “road object(s)” and/or “landmark(s)”. As used herein, observation data or observation associated with an object may correspond to raw or processed sensor data corresponding to the object.

In some other embodiments, the system 101 may be embodied as a server 103b of the mapping platform 103 and therefore may be co-located with or within the mapping platform 103. In yet some other embodiments, the system 101 may be implemented within an OEM (Original Equipment Manufacturer) cloud, such as the OEM cloud 109. The OEM cloud 109 may be configured to anonymize any data received from the vehicle, before using the data for further processing, such as before sending the data to the mapping platform 103. In some embodiments, anonymization of data may be done by the mapping platform 103. Further, in some example embodiments, the system 101 may be a standalone unit configured to process the observations associated with the one or more objects. Additionally, the system 101 may be coupled with an external device such as the autonomous vehicle.

The mapping platform 103 may comprise the map database 103a (also referred to as geographic database 103a) for storing map data and a processing server 103b for carrying out the processing functions associated with the mapping platform 103. The map database 103a may store, as the map data: node data, road segment data or link data, point of interest (POI) data, and/or object data. The map database 103a may also store, as the map data, cartographic data and/or routing data.

According to some example embodiments, the link data may be stored in link data records, where the link data may represent links or segments representing roads, streets, or paths, as may be used in calculating a route or recorded route information for determination of one or more personalized routes. The node data may be stored in node data records, where the node data may represent end points corresponding to the respective links or segments of the road segment data. One node represents a point at one end of the respective link and the other node represents a point at the other end of the respective link. The node at either end of a link corresponds to a location at which the road meets another road, e.g., an intersection, or where the road dead ends. An intersection may not necessarily be a place at which a turn from one road to another is permitted but represents a location at which one road and another road have the same latitude, longitude, and elevation. In some cases, a node may be located along a portion of a road between adjacent intersections, e.g., to indicate a change in road attributes, a railroad crossing, or for some other reason. The link data and the node data may represent a road network used by vehicles such as cars, trucks, buses, motorcycles, and/or other entities.

Additionally, the map database 103a may store path segment and node data records, or other data that may represent pedestrian paths or areas in addition to or instead of the vehicle road record data, for example. The links/road segments and nodes may be associated with attributes, such as geographic coordinates and other navigation related attributes, as well as POIs, such as fueling stations, hotels, restaurants, museums, stadiums, offices, auto repair shops, buildings, stores, parks, etc. The navigation related attributes may include one or more of travel speed data (e.g. data indicative of a permitted speed of travel) on the road represented by the link data record, a travel direction data (e.g. data indicative of a permitted direction of travel) on the road represented by the link data record, the linear feature data on the road represented by the link data record, the road lane detection data on the road represented by the link data record, street address ranges of the road represented by the link data record, the name of the road represented by the link data record, and the like.

According to some example embodiments, the object data stored in the map database 103a may include ground truth data associated with the one or more objects and/or data related to the one or more objects. In various embodiments, the ground truth data associated with the one or more objects may include map statuses of the one or more objects. For instance, a map status of an object may either correspond to a presence state or an absence state of the object. In a case where the map status of an object corresponds to the presence state, the ground truth data associated with the object may indicate a presence of the object in the map data. Alternatively, when the map status of the object corresponds to the absence state, the ground truth data associated with the object may indicate an absence of the object in the map data. In various embodiments, the ground truth data associated with the one or more objects may be derived from the sensor data collected from the ground truth collection vehicle(s) and/or the probe vehicle(s). The data related to the one or more objects may include object type information of the one or more objects, location information of the one or more objects, map identity information of the one or more objects, and/or the like.

Additionally, the map database 103a may also include data about the POIs and their respective locations in the POI records. The map database 103a may further include data about places, such as cities, towns, or other communities, and other geographic features such as bodies of water, mountain ranges, etc. Such place or feature data may be part of the POI data or may be associated with POIs or POI data records (such as a data point used for displaying a city). In addition, the map database 103a may include event data (e.g., traffic incidents, construction activities, scheduled events, unscheduled events, etc.) associated with the POI data records or other records of the map database 103a.

The map database 103a may be maintained by a content provider, e.g., a map developer. By way of example, the map developer may collect the map data to generate and enhance the map database 103a. There may be different ways used by the map developer to collect data, such ways including obtaining data from other sources, such as municipalities or respective geographic authorities. In addition, the map developer may employ field personnel to travel by vehicle (also referred to as a dedicated vehicle) along roads throughout a geographic region to observe features and/or record information about them, for example. Also, remote sensing, such as aerial or satellite photography, may be used to collect the map data. In some example embodiments, the map data in the map database 103a may be stored as a digital map.

According to some embodiments, the map database 103a may be a master map database stored in a format that facilitates updating, maintenance and development. The data in the production and/or delivery formats may be compiled or further compiled to form geographic database products or databases, which may be used in end user navigation devices or systems.

For example, the map data may be compiled (such as into a platform specification format (PSF format)) to organize and/or configure the data for performing navigation-related functions and/or services, such as route calculation, route guidance, map display, speed calculation, distance and travel time functions, navigation instruction generation and other functions, by a navigation device, such as by the user equipment 107a and/or 107b. The navigation-related functions may correspond to vehicle navigation, pedestrian navigation, navigation instruction suppression, navigation instruction generation based on user preference data or other types of navigation.

As mentioned above, the map database 103a may be a master geographic database, but in alternate embodiments, the map database 103a may be embodied as a client-side map database and may represent a compiled navigation database that may be used in or with end user equipment such as the user equipment 107a and/or the user equipment 107b to provide navigation and/or map-related functions. For example, the map database 103a may be used with the user equipment 107a and/or the user equipment 107b to provide an end user with navigation features. In such a case, the map database 103a may be downloaded or stored locally (cached) on the user equipment 107a and/or the user equipment 107b.

The processing server 103b may comprise processing means, and communication means. For example, the processing means may comprise one or more processors configured to process requests received from the user equipment 107a and/or the user equipment 107b. The processing means may fetch map data from the map database 103a and transmit the same to the user equipment 107b via the OEM cloud 109 in a format suitable for use by the one or both of the user equipment 107a and/or the user equipment 107b. In one or more example embodiments, the mapping platform 103 may periodically communicate with the user equipment 107a and/or the user equipment 107b via the processing server 103b to update a local cache of the map data stored on the user equipment 107a and/or the user equipment 107b. Accordingly, in some example embodiments, the map data may also be stored on the user equipment 107a and/or the user equipment 107b and may be updated based on periodic communication with the mapping platform 103 via the network 105.

The network 105 may be wired, wireless, or any combination of wired and wireless communication networks, such as cellular, Wi-Fi, internet, local area networks, or the like. In one embodiment, the network 105 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

In some example embodiments, the user equipment 107a and the user equipment 107b may be any user accessible device such as a mobile phone, a smartphone, a portable computer, and the like that are portable in themselves or as a part of another portable/mobile object such as a vehicle. The user equipment 107a and 107b may comprise a processor, a memory, and a communication interface. The processor, the memory, and the communication interface may be communicatively coupled to each other. In some example embodiments, the user equipment 107a and 107b may be associated, coupled, or otherwise integrated with a vehicle, such as an advanced driver assistance system (ADAS), a personal navigation device (PND), a portable navigation device, an infotainment system and/or other device that may be configured to provide route guidance and navigation related functions to the user. In such example embodiments, the user equipment 107a and 107b may comprise processing means such as a central processing unit (CPU), storage means such as on-board read only memory (ROM) and random access memory (RAM), acoustic sensors such as a microphone array, position sensors such as a GPS sensor, gyroscope, a LIDAR sensor, a proximity sensor, motion sensors such as accelerometer, a display enabled user interface such as a touch screen display, and other components as may be required for specific functionalities of the user equipment 107a and 107b. For example, the user equipment 107a and 107b may be configured to execute and run mobile applications such as a messaging application, a browser application, a navigation application, and the like.

In one embodiment, at least one user equipment such as the user equipment 107a may be directly coupled to the system 101 via the network 105. For example, the user equipment 107a may be a dedicated vehicle (or a part thereof) for gathering data for development of the map data stored in the map database 103a. In another embodiment, at least one user equipment such as the user equipment 107b may be coupled to the system 101 via the OEM cloud 109 and the network 105. For example, the user equipment 107b may be a consumer vehicle (or a part thereof) and may be a beneficiary of the services provided by the system 101. In some example embodiments, one or more of the user equipment 107a and 107b may serve the dual purpose of a data gatherer and a beneficiary device. At least one of the user equipment 107a and 107b may be configured to capture sensor data associated with the link/road segment, while traversing along the link/road segment. For example, the sensor data may include image data associated with the one or more road objects along the link/road segment, among other things. The sensor data may be collected from one or more sensors in the user equipment 107a and/or user equipment 107b. As disclosed in conjunction with various embodiments disclosed herein, the system 101 may update the map data of the map database 103a using the sensor data.

In operation, the system 101 may be configured to obtain observation data associated with each observation of a plurality of observations captured by one or more user equipment such as user equipment 107a or user equipment 107b. The plurality of observations may be associated with an object that requires validation in the map database 103a. According to some embodiments, the object may be any object on a road segment in a geographic area. As such the road object may encompass any of road obstacles, traffic objects, posted signs (e.g., road signs), lane markings, road edges, ramps, and/or the like. According to some other embodiments, the object may be a landmark detected by autonomous appliances and/or service robots.

In an embodiment, the system 101 may further obtain from the map database 103a, map data corresponding to the object. In this regard, for example, the system 101 may query the database 103a using one or more indexing identifiers associated with the object. According to some embodiments, the map data for the object may be obtained in relation to a location associated with the object. For example, the system 101 may obtain location data associated with the object from the corresponding observation data of the object. In some embodiments, the map data of the object may serve as ground truth data associated with the object where the ground truth data indicates one of a presence of the object in the map data, or an absence of the object in the map data.

In an embodiment, the system 101 may classify each observation of the plurality of observations as an observation feature, based on the observation data of a corresponding observation and the ground truth data/map data. In this regard, the system 101 may compare the observation data of each observation with the ground truth data to obtain a corresponding result based on which, the system further generates a classification matrix for each corresponding observation of the plurality of observations. According to some embodiments, the classification matrix may be a confusion matrix or error matrix. Each element of the classification matrix corresponds to an observation feature. In this way, the system 101 derives a plurality of observation features corresponding to the plurality of observations.

In some embodiments, the system 101 may further determine a generalized probability distribution for the plurality of observations, based on the classification of each observation of the plurality of observations. The generalized probability distribution includes a set of probability values for a set of observation features of the plurality of observation features. In this regard, the system 101 may determine an individual probability distribution for each observation of the plurality of observations, based on the classification matrix of a corresponding observation of the plurality of observations. The generalized probability distribution may be generated based on the individual probability distribution of each observation of the plurality of observations.

According to some embodiments, the classification matrix of each observation of the plurality of observations includes a first column corresponding to a set of positive observation features of the plurality of observation features and a second column corresponding to a set of negative observation features of the plurality of observation features. In some embodiments, the system determines the individual probability distribution for an observation using a normalized matrix obtained by normalizing the classification matrix for the observation. Towards this end, the individual probability distribution is determined based on the first column or the second column of the normalized matrix. As such, the set of observation features corresponds to one of the set of positive observation features or the set of negative observation features.

Furthermore, the system 101 may determine a confidence score for the plurality of observations based on the generalized probability distribution and determine updated status data of the object based on the ground truth data and the confidence score. Furthermore, the system 101 may update the map database based on the updated status data of the object.

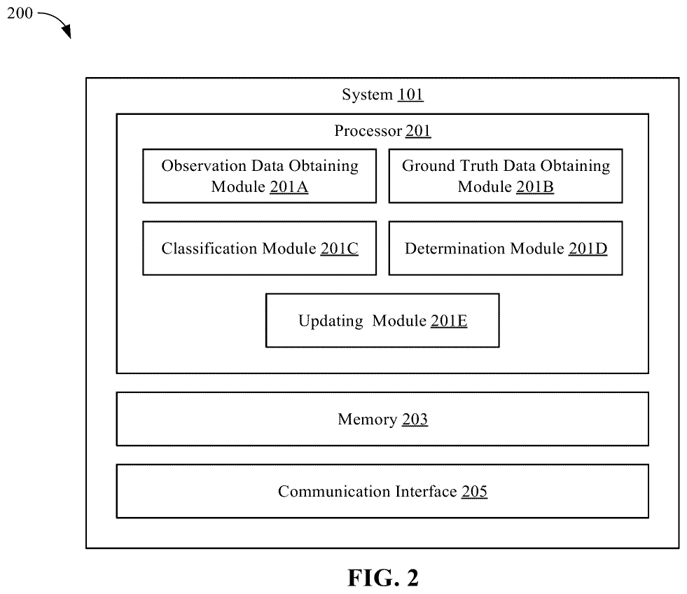

FIG. 2 illustrates a block diagram 200 showing the system 101 for updating the map database 103a by processing the observations, in accordance with one or more example embodiments. The system 101 may include at least one processor 201, a memory 203, and a communication interface 205. Further, the system 101 may include an observation data obtaining module 201a, a ground truth data obtaining module 201b, a classification module 201c, a determination module 201d, and an updating module 201c. In some embodiments, the observation data obtaining module 201a may be configured to receive the observations associated with the object. In an embodiment, the observations may be received from the user equipment 107a and/or the user equipment 107b. Each of the user equipment 107a and the user equipment 107a may be a movable device or be installed in a vehicle (such as the consumer or “probe” vehicle) or a robot, or may be a handheld device such as a smartphone. Hereinafter, the description of some embodiments will be provided considering the user equipment to be installed in a vehicle, however, it may be contemplated that the operations of the system may similarly be executed with other implementations of the user equipment that are described above. The vehicle may be equipped with one or more sensors such as a camera, an acceleration sensor (i.e., accelerometer), a gyroscopic sensor (i.e., gyroscope), a LIDAR sensor, a proximity sensor, a motion sensor, a positioning sensor (e.g., GNSS such as GPS), a wheel odometry, and the like. The sensors may detect sensor data associated with the object. Additionally, or alternatively, the sensors may determine vehicle's position and orientation. The user equipment 107a and/or the user equipment 107b may be configured to derive the observations using the sensor data and/or the vehicle's position and orientation. Further, the observation data obtaining module 201a may be configured to obtain observation data associated with each of the observations. The observation data associated with an observation of the observations may include object type information of the object, location information of the object, identity information (such as map ID) of the object, time-stamp of the object observation, and/or the like. Additionally, or alternatively, the observation data may include relative position estimates of the object from the vehicle's position.

The ground truth data obtaining module 201b may be configured to obtain the ground truth data associated with the object. In an embodiment, the ground truth data may be obtained from the map database 103a. The ground truth data may indicate one of a presence of the object in the map data of the map database 103a or an absence of the object in the map data of the map database 103a. The classification module 201c may be configured to classify each observation of the plurality of observations as one observation feature of a plurality of observation features. In an embodiment, an observation of the plurality of observations may be classified as an observation feature of the plurality of observation features by comparing the observation associated with the observation with the ground truth data. For instance, the plurality of observation features may include two or more of a true positive observation feature, a false positive observation feature, a true negative observation feature, or a false negative observation feature.

The determination module 201d may be configured to determine a generalized probability distribution for the observations based on the classification of each observation of the observations. In an embodiment, the generalized probability distribution includes a set of probability values for a set of observation features of the plurality of observation features. Further, the determination module 201d may be configured to determine a confidence score, for the observations, where the confidence score indicates a confidence to update the map data of the map database 103a to add, retain, or remove the object corresponding to the observations in the map database. In an embodiment, the confidence score may be determined based on the determined generalized probability distribution. Furthermore, the determination module 201d may be configured to determine updated status data of the object and output the updated status data to the updating module 201c. In an embodiment, the updated status data may be determined based on the ground truth data and the confidence score.

The updating module 201c may be configured to update the map database 103a based on the updated status data. Specifically, the map data (i.e., the object data) of the map database 103a may be updated based on the updated status data. In one embodiment, each of the modules 201a, 201b, 201c, 201d, and 201e may be embodied in the at least one processor 201. In another embodiment, each of the modules 201a, 201b, 201c, 201d, and 201e may be stored in the memory 203. In this embodiment, the at least one processor 201 may retrieve each of the modules 201a, 201b, 201c, 201d, and 201c stored in the memory 203 and execute each of the modules 201a, 201b, 201c, 201d, and 201e for updating the map database 103a.

The at least one processor 201 may be embodied in a number of different ways. For example, the at least one processor 201 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), a GPU (Graphics Processing Unit), an AI engine (Artificial Intelligence enabled processing engine), an Quantum processor, an FPGA (field programmable gate array), a microcontroller unit (MCU), a hardware accelerator, a special-purpose computer chip, or the like. As such, in some embodiments, the at least one processor 201 may include one or more processing cores configured to perform independently. A multi-core processor may enable multiprocessing within a single physical package. Additionally, or alternatively, the at least one processor 201 may include one or more processors configured in tandem via the bus to enable independent execution of instructions, pipelining and/or multithreading.

Additionally, or alternatively, the at least one processor 201 may include one or more processors capable of processing large volumes of workloads and operations to provide support for big data analysis. In an example embodiment, the at least one processor 201 may be in communication with the memory 203 via a bus for passing information to the mapping platform 103. The memory 203 may be non-transitory and may include, for example, one or more volatile and/or non-volatile memories. In other words, for example, the memory 203 may be an electronic storage device (for example, a computer readable storage medium) comprising gates configured to store data (for example, bits) that may be retrievable by a machine (for example, a computing device like the at least one processor 201). The memory 203 may be configured to store information, data, content, applications, instructions, or the like, for enabling the system 101 to carry out various functions in accordance with an example embodiment of the present disclosure. For example, the memory 203 may be configured to buffer input data for processing by the at least one processor 201.

As exemplarily illustrated in FIG. 2, the memory 203 may be configured to store instructions for execution by the at least one processor 201. As such, whether configured by hardware or software methods, or by a combination thereof, the at least one processor 201 may represent an entity (for example, physically embodied in circuitry) capable of performing operations according to an embodiment of the present disclosure while configured accordingly. Thus, for example, when the at least one processor 201 is embodied as an ASIC, FPGA or the like, the at least one processor 201 may be specifically configured hardware for conducting the operations described herein. Alternatively, as another example, when the at least one processor 201 is embodied as an executor of software instructions, the instructions may specifically configure the at least one processor 201 to perform the algorithms and/or operations described herein when the instructions are executed. However, in some cases, the at least one processor 201 may be a processor specific device (for example, a mobile terminal or a fixed computing device) configured to employ an embodiment of the present disclosure by further configuration of the at least one processor 201 by instructions for performing the algorithms and/or operations described herein. The at least one processor 201 may include, among other things, a clock, an arithmetic logic unit (ALU) and logic gates configured to support operation of the processor 201.

In some embodiments, the at least one processor 201 may be configured to provide Internet-of-Things (IoT) related capabilities to a user of the system 101, where the user may be a traveler, a driver of the vehicle and the like. In some embodiments, the user may be or correspond to an autonomous or semi-autonomous vehicle. The IoT related capabilities may in turn be used to provide smart navigation solutions by providing real time updates to the user to take pro-active decision on lane maintenance, speed determination, lane-level speed determination, turn-maneuvers, lane changes, overtaking, merging and the like. The system 101 may be accessed using the communication interface 205. The communication interface 205 may provide an interface for accessing various features and data stored in the system 101. For example, the communication interface 205 may comprise I/O interface which may be in the form of a GUI, a touch interface, a voice enabled interface, a keypad, and the like. For example, the communication interface 205 may be a touch enabled interface of a navigation device installed in a vehicle, which may also display various navigation related data to the user of the vehicle. Such navigation related data may include information about upcoming conditions on a route, route display and alerts about lane maintenance, turn-maneuvers, vehicle speed, and the like.

Hereinafter, without limitation and for explanatory purposes only, the term “object” may be treated as a road object and likewise the term observation may be treated as a road object observation. However, the term “object” is not to be limited to road objects alone and may also include landmarks, such as physical objects, points of interest (POIs), and/or celestial objects. The physical objects may include notable objects detected by various autonomous service robots such as delivery robots, pet robots, and/or industrial robots. Additionally, or alternatively, the physical objects may include notable objects detected by automated appliances such as lawn mowers, vacuum cleaners, etc. The POIs may include restaurants, gas stations, museums, shopping malls, hospitals, and/or the like. The celestial objects may include stars, comets, and/or the like.

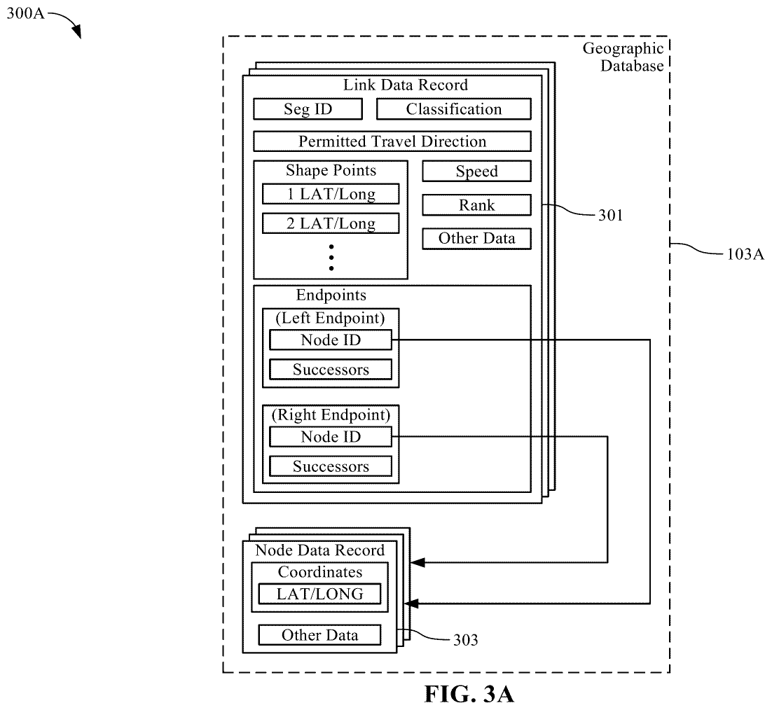

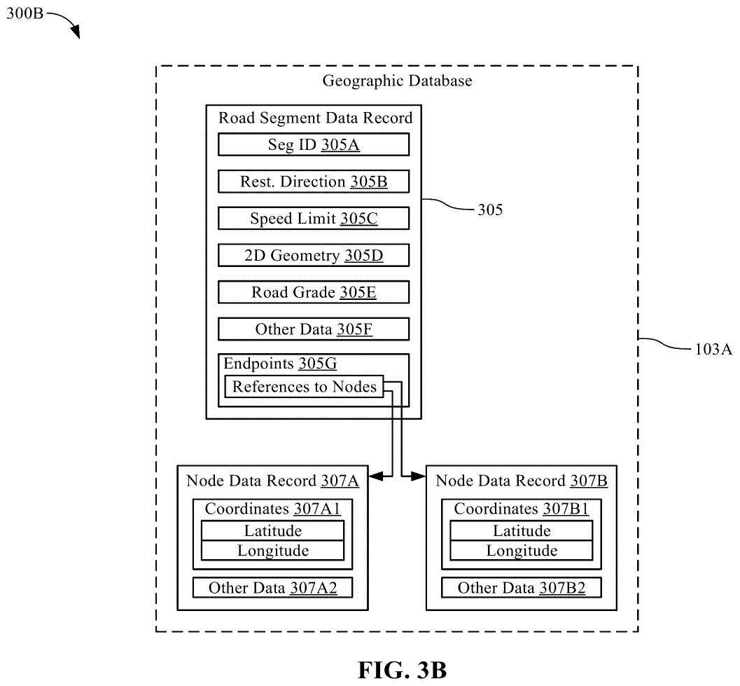

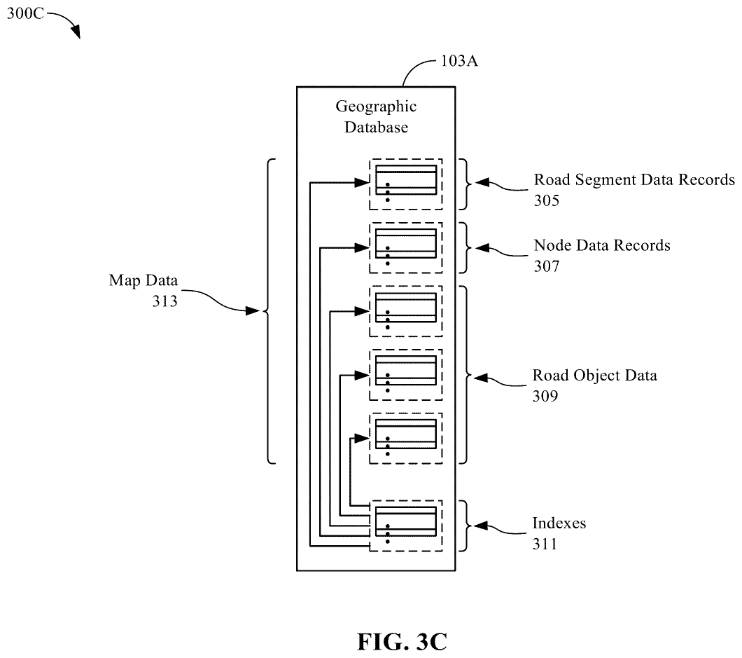

FIG. 3A illustrates a block diagram 300A showing a format of the map data stored in the map database 103a, in accordance with one or more example embodiments. The block diagram 300A includes a link data record 301 that may be used to store data about one or more of the road links. This link data record 301 has information (such as “attributes”, “fields”, etc.) associated with it that allows identification of the nodes associated with the road link and/or the geographic positions (e.g., the latitude and longitude coordinates and/or altitude or elevation) of the two nodes. In addition, the link data record 301 may have information (e.g., more “attributes”, “fields”, etc.) associated with it that specify the permitted speed of travel on the portion of the road represented by the link data record 301, the direction of travel permitted on the road portion represented by the link data record 301, what, if any, turn restrictions exist at each of the nodes which correspond to intersections at the ends of the road portion represented by the link record, the street address ranges of the roadway portion represented by the link record, the name of the road, and so on. The various attributes associated with a link may be included in a single data record or are included in more than one type of record which are referenced to each other.

Each link data record that represents an other-than-straight road segment may include shape point data. A shape point is a location along a link between its endpoints. To represent the shape of other-than-straight roads, the mapping platform 103 and its associated map database developer selects one or more shape points along the other-than-straight road portion. Shape point data included in the link data record 301 indicate the position, (e.g., latitude, longitude, and optionally, altitude or elevation) of the selected shape points along the represented road link.

Additionally, in the compiled geographic database, such as a copy of the map database 103a that is compiled and provided to the user, there may also be a node data record 303 for each node. The node data record 303 may have associated with it information (such as “attributes”, “fields”, etc.) that allows identification of the link(s) that connect to it and/or its geographic position (e.g., its latitude, longitude, and optionally altitude or elevation).

In some embodiments, compiled geographic databases are organized to facilitate the performance of various navigation-related functions. One way to facilitate performance of navigation-related functions is to provide separate collections or subsets of the geographic data for use by specific navigation-related functions. Each such separate collection includes the data and attributes needed for performing the particular associated function but excludes data and attributes that are not needed for performing the function. Thus, the map data may be alternately stored in a format suitable for performing types of navigation functions, and further may be provided on-demand, depending on the type of navigation function.

FIG. 3B illustrates a block diagram 300B showing another format of the map data stored in the map database 103a, in accordance with one or more example embodiments. As shown in the block diagram 300B, the map data in the map database 103a is stored by specifying a road segment data record 305. The road segment data record 305 is configured to represent data that represents a road network. Further, the map database 103a contains at least one road segment data record 305 (also referred to as “entity” or “entry”) for each road segment in a geographic region.

The map database 103a that represents the geographic region also includes a database record (or “entity” or “entry”) for each node associated with the at least one road segment shown by the road segment data record 305. The terms “nodes” and “segments” represent only one terminology for describing these physical geographic features and other terminology for describing these features is intended to be encompassed within the scope of these concepts. Each of the node data records 307a and 307b may have associated information (such as “attributes”, “fields”, etc.) that allows identification of the road segment(s) that connect to it and/or its geographic position (e.g., its latitude and longitude coordinates).

FIG. 3B also illustrates some of the components of the road segment data record 305 contained in the map database 103a. The road segment data record 305 includes a segment ID 305a by which the data record can be identified in the map database 103a. Each road segment data record 305 has associated with it information (such as “attributes”, “fields”, etc.) that describes features of the represented road segment. The road segment data record 305 may include data 305b that indicate the restrictions, if any, on the direction of vehicular travel permitted on the represented road segment. The road segment data record 305 includes data 305c that indicates a static speed limit or speed category (i.e., a range indicating maximum permitted vehicular speed of travel) on the represented road segment. The static speed limit is a term used for speed limits with a permanent character, even if they are variable in a pre-determined way, such as dependent on the time of the day or weather. The static speed limit is the sign posted explicit speed limit for the road segment, or the non-sign posted implicit general speed limit based on legislation.

The road segment data record 305 may also include data 305d indicating the two-dimensional (“2D”) geometry or shape of the road segment. If a road segment is straight, its shape can be represented by identifying its endpoints or nodes. However, if a road segment is other-than-straight, additional information is required to indicate the shape of the road. One way to represent the shape of an other-than-straight road segment is to use shape points. Shape points are points through which a road segment passes between its end points. By providing the latitude and longitude coordinates of one or more shape points, the shape of an other-than-straight road segment can be represented. Another way of representing other-than-straight road segment is with mathematical expressions, such as polynomial splines.

The road segment data record 305 also includes road grade data 305e that indicate the grade or slope of the road segment. In one embodiment, the road grade data 305e includes road grade change points and a corresponding percentage of grade change. Additionally, the road grade data 305e may include the corresponding percentage of grade change for both directions of a bi-directional road segment. The location of the road grade change point is represented as a position along the road segment, such as thirty feet from the end or node of the road segment. For example, the road segment may have an initial road grade associated with its beginning node. The road grade change point indicates the position on the road segment wherein the road grade or slope changes, and percentage of grade change indicates a percentage increase or decrease of the grade or slope. Each road segment may have several grade change points depending on the geometry of the road segment. In another embodiment, the road grade data 305e includes the road grade change points and an actual road grade value for the portion of the road segment after the road grade change point until the next road grade change point or end node. In a further embodiment, the road grade data 305e includes elevation data at the road grade change points and nodes. In an alternative embodiment, the road grade data 305e is an elevation model which may be used to determine the slope of the road segment.

The road segment data record 305 may also include other data 305f that refer to various other attributes of the road segment. The other data 305f may be included in a single road segment record or may be included in more than one type of record which cross-reference each other. The road segment data record 305 may also include data 305g providing the geographic coordinates (e.g., the latitude and longitude) of the end points of the represented road segment. In one embodiment, the data 305g are references to the node data records 307a and 307b that represent the nodes corresponding to the end points of the represented road segment.

The block diagram 300B also shows some of the components of the node data records 307a and 307b contained in the map database 103a. Each of the node data records 307a and 307b may have associated information (such as “attributes”, “fields”, etc.) that allows identification of the road segment(s) that connect to it and/or its geographic position (e.g., its latitude and longitude coordinates). For instance, the node data records 307a and 307b include the latitude and longitude coordinates 307a1 and 307b1 for their nodes. The node data records 307a and 307b may also include other data 307a2 and 307b2 that refer to various other attributes of the nodes.

Thus, the overall data stored in the map database 103a may be organized in the form of different layers for greater detail, clarity, and precision. Specifically, in the case of high-definition maps, the map data may be organized, stored, sorted, and accessed in the form of three or more layers. These layers may include road level layer, lane level layer and localization layer. The data stored in the map database 103a in the formats shown in FIG. 3A and FIG. 3B may be combined in a suitable manner to provide these three or more layers of information. In some embodiments, there may be lesser or fewer number of layers of data also possible, without deviating from the scope of the present disclosure.

FIG. 3C illustrates a block diagram 300C of the map database 103a storing map data 123 in the form of road segments/links, nodes, and one or more associated attributes as discussed above. Furthermore, attributes may refer to features or data layers associated with the link-node database, such as an HD lane data layer.

In addition, the map data 313 may also include road object data 309. The road object data 309 may represent the one or more road objects. As used herein, the one or more road objects may correspond to road obstacles, traffic objects, posted signs (e.g., road signs), lane markings, road edges, and/or the like. These one or more road objects may be associated with the road segments represented by the road segment data records 305 or may be associated with the nodes represented by the node data records 307. The road object data 309 may include data related to the one or more road objects. The data related to the one or more road objects may include road object type information of the one or more road objects, location information of the one or more road objects, map identity information of the one or more road objects, and/or the like. Additionally, or alternatively, the road object data 309 may include the ground truth data associated with the one or more road objects. The ground truth data may include the map statuses of the one or more road objects. For instance, a map status of a road object of the one or more road objects may indicate a present state for the road object when the road object is present on the road segment represented by the road segment data records 305.

Additionally, the map database 103a may include indexes 311. The indexes 311 may include various types of indexes that relate the different types of data to each other or that relate to other aspects of the data contained in the geographic database 103a.

Some embodiments are based on the realization that the map data 313 stored in the map database 103a may be used to provide precise data for high-definition mapping applications, autonomous vehicle navigation and guidance, cruise control using ADAS, direction control using accurate vehicle maneuvering and other such services. Therefore, it is crucial for the map data 313 to accurately correspond with the real-world environments of the navigation vehicles. However, navigation features, such as the road objects, associated with the road segments may change over time and/or due to developments, such as the construction of new road segments. To address these situations, the system 101 is configured to update the map data 313 by processing the observations associated with objects such as road objects and landmarks.

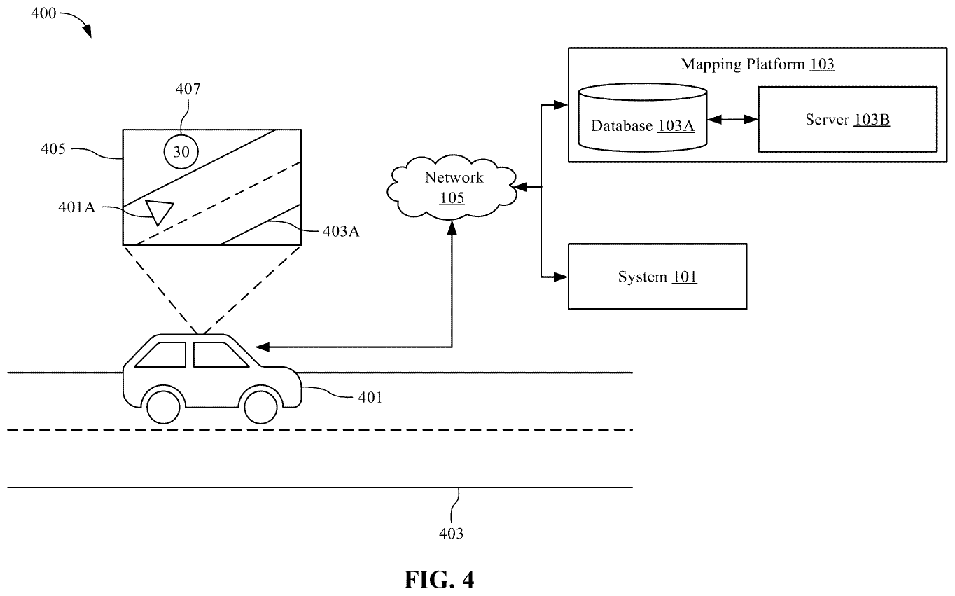

FIG. 4 illustrates an exemplary working environment 400 of the system 101 for updating the map database 103a, in accordance with one or more example embodiments. As illustrated in FIG. 4, the working environment 400 may include the system 101, the mapping platform 103, the network 105, a vehicle 401, and a link 403. The vehicle 401 may correspond to an autonomous vehicle, a semiautonomous vehicle, or a manual vehicle. In various embodiments, the vehicle 401 may be equipped with, but not limited to, sensors such as a camera sensor, a positioning sensor, a RADAR sensor, a LIDAR sensor and like for collecting the sensor data associated with the link 403. As used herein, the link 403 may correspond to a road segment between two nodes or two intersections. For instance, the link 403 may be a freeway, a highway, an expressway, or the like. In some embodiments, the link 403 may be associated with one or more road objects. In these embodiments, the sensors of the vehicle 401 may also collect the sensor data associated with the one or more road objects. As used herein, the one or more road objects may include a road sign, a road obstacle, a traffic object, and the like. The road sign may correspond to a speed limit sign, a route guidance sign, a parking sign, a destination sign, a warning sign, or the like. The road obstacle may correspond to a road divider, a road work object, or the like. The traffic object may correspond to a traffic cone, a guide rail, or the like.

In various embodiments, the vehicle 401 may be equipped with at least one user equipment (such as the user equipment 107a and/or 107b). The at least one user equipment may execute, using the sensor data (e.g., location data of the vehicle 401), a map matching process to determine the link 403 on which the vehicle 401 is traveling. Further, the at least one user equipment may obtain map data 405 associated with the link 403 based on the execution of the map matching process.

In an embodiment, the map data 405 may be rendered such that the map data 405 comprises a vehicle indicator 401A indicating the vehicle 401, a link 403A, and a road object 407 (e.g., the speed limit sign). For instance, the link 403A may correspond to the link 403 on which the vehicle is traveling. Furthermore, the at least one user equipment may determine whether a mismatch, between the obtained map data 405 and the collected sensor data, exists. Specifically, the at least one user equipment may determine whether the road object 407 present in the map data 405 is missing in the sensor data collected by the sensors. Conversely, the at least one user equipment may determine whether a road object present in the sensor data is missing in the obtained map data 405.

In a case where the mismatch between the obtained map data 405 and the collected sensor data exists, the at least one user equipment may send, to the system 101, a report including a negative road object observation. In one embodiment, the negative road object observation may include the collected sensor data and/or the obtained map data 405. In another embodiment, the negative road object observation may include status data of the road object 407, road object type information of the road object 407, location information of the road object 407, map identity information of the road object 407, time-stamp data of the negative road object observation, and/or the like. The status data of the road object 407 may indicate one of a presence of the road object 407 on the link 403 or an absence of the road object 407 on the link 403. The road object type information of the road object 407 may indicate a type (e.g., the speed limit sign) of the road object 407. The location information of the road object 407 may indicate a position where the road object 403 is placed on a link (e.g., the link 403A or 403). The map identity information of the road object 407 may indicate a map identity (ID) of the road object 407. The time-stamp data may indicate the time of day when the sensor data was captured. Each of the status data, the road object type information, the location information, the map identity information, and the time-stamp data may be derived from the collected sensor data and/or the obtained map data 405.

Additionally, or alternatively, the negative road object observation may include meta data. For instance, the meta data may include environmental data associated with the negative road object observation, occlusion data associated with the negative road object observation, and/or the like. The environmental data may indicate weather condition(s) (like rainy, foggy, etc.) around the vehicle 401 when the sensor data was captured. The occlusion data may indicate if the vehicle 401 was surrounded by other vehicles when the sensor data was captured.

In a case where the mismatch between the obtained map data 405 and the sensor data does not exist, the at least one user equipment may send, to the system 101, a report including a positive road object observation. In other words, when the road object 407 exists on the link 403, the at least one user equipment may send, to the system 101, the positive road object observation including the status data of the road object 407, the road object type information of the road object 407, the location information of the road object 407, the map identity information of the road object 407, and/or the like.

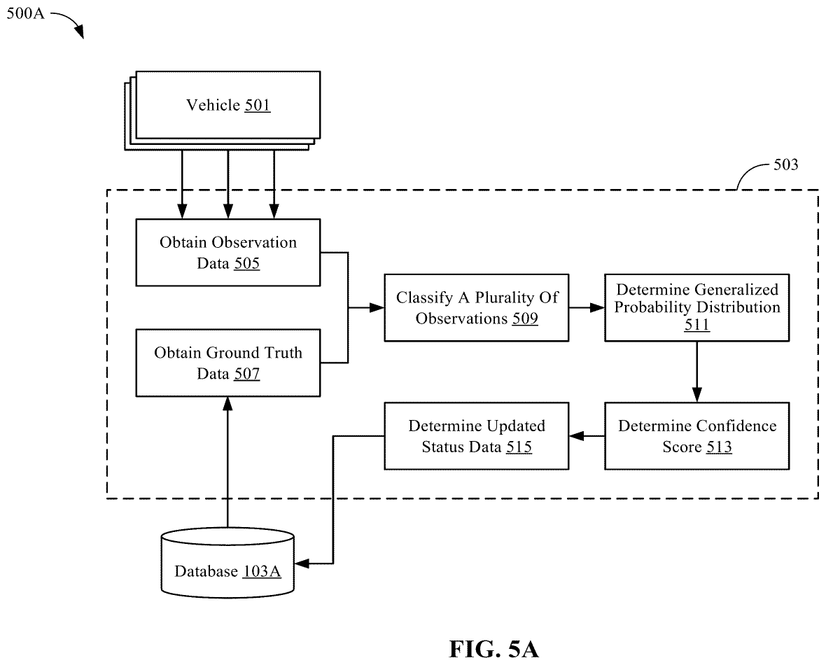

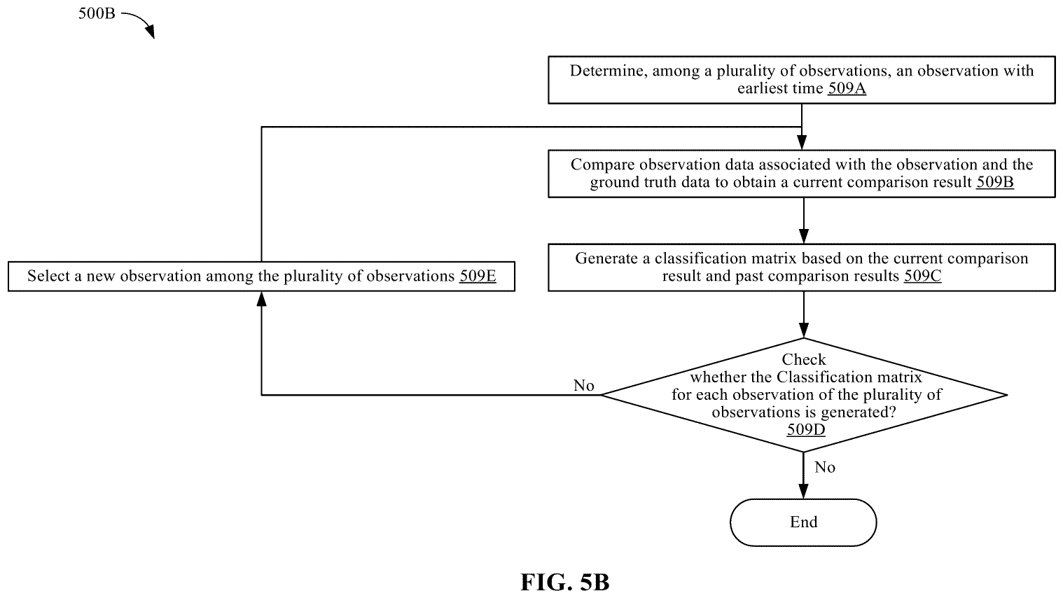

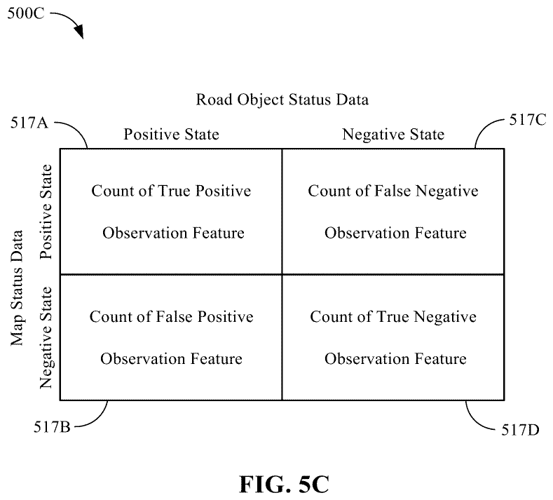

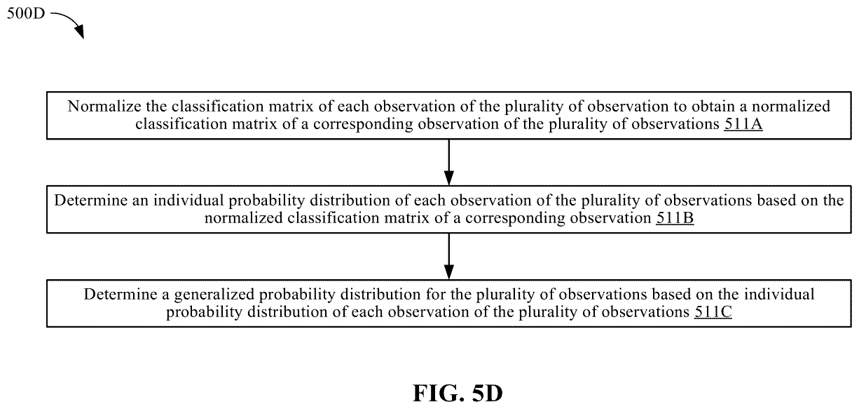

To this end, the system 101 may be configured to receive, from a plurality of vehicles that are similar to the vehicle 401, a plurality of road object observations including multiple positive road object observations and multiple negative positive road object observations. Hereinafter, the plurality of road object observations may be referred to as a plurality of observations. Further, the system 101 may be configured to execute, based on the plurality of observations, an update process to update the map database 103a. For instance, the update process executed by the system 101 is as explained in the detailed description of FIG. 5A-FIG. 5D.

FIG. 5A illustrates a block diagram 500A showing an update process framework 503 for updating the map database 103a, in accordance with one or more example embodiments. As illustrated in FIG. 5A, the block diagram 500A includes a plurality of vehicles 501, the update process framework 503, and the map database 103a. Each vehicle of the plurality of vehicles 501 may correspond to the vehicle 401 (illustrated in FIG. 4). In various embodiments, the plurality of vehicles 501 may report, to the system 101, the plurality of observations associated with an object such as the road object (e.g., the road object 407). Upon the reception of the plurality of observations, the system 101 may execute the update process framework 503 to update the map database 103a.

At block 505 of the update process framework 503, the system 101 may be configured to obtain observation data associated with each observation of the plurality of observations. Hereinafter, the observation data associated with each observation of the plurality of observations may be referred to as a plurality pieces of observation data. In an embodiment, the plurality of observations may include raw sensor data collected by the sensors of the plurality of vehicles 501. In this embodiment, the system 101 may derive the plurality pieces of observation data from the plurality of observations, where each piece of observation data of the plurality pieces of observation data is associated with a corresponding observation of the plurality of observations. Each piece of observation data of the plurality pieces of observation data includes the status data of the road object (e.g., the road object 407 of FIG. 4), the road object type information of the road object, the location information of the road object, the map identity information of the road object, the time-stamp data, and/or the meta data.

In another embodiment, each observation of the plurality of observations may include the status data of the road object, the road object type information of the road object, the location information of the road object, the map identity information of the road object, the time-stamp data, and/or the meta data. In this embodiment, the system may extract each of the status data, the road object type information, the location information, the map identity information, and/or the meta data included in each observation of the plurality of observations as a corresponding piece of observation data of the plurality pieces of observation data.

At block 507 of the update process framework 503, the system 101 may be configured to obtain, from the map database 103a, ground truth data associated with the road object (e.g., the road object 407). In an embodiment, the ground truth data associated with the road object may be obtained based on the plurality pieces of observation data. For instance, the ground truth data associated with the road object may be obtained using the map identity information of the road object. In various embodiments, the obtained ground truth data may indicate one of a presence of the road object in the map data of the map database 103a or an absence of the road object in the map data of the map database 103a. For instance, the obtained ground truth data may include a map status of the road object, where the map status may indicate either a presence state or an absence state. If the road object is included in the map data of the map database 103a, then the map status of the road object indicates the presence state. Conversely, if the road object is not included in the map data of the map database 103a, then the map status of the road object indicates the absence state.

At block 509 of the update process framework 503, the system 101 may be configured to classify each observation of the plurality of observations as an observation feature of the plurality of observation features. In various embodiments, the plurality of observation features includes a set of positive observation features and a set of negative observation features. The set of positive observation features includes at least one of a true positive observation feature or a false positive observation feature. The set of negative observation features includes at least one of a true negative observation feature or a false negative observation feature.

In various embodiments, the system 101 may be configured to classify, as one of plurality of observation features, each observation of the plurality of observations based on the obtained ground truth data and the obtained plurality pieces of observation data. For instance, the classification of the plurality of observations is as explained in the detailed description of FIG. 5B.

FIG. 5B illustrates a flowchart showing a process 500B for classifying the plurality of observations, in accordance with one or more example embodiments. In an embodiment, the system 101 may be configured to execute the process 500B for classifying each observation of the plurality of observations as an observation feature of the plurality of observation features. At block 509a, the system 101 may be configured to determine, among the plurality of observations, an observation that is associated with earliest time instance. For instance, the system 101 may determine, based on the time-stamp data of each observation of the plurality of observations, the observation associated with the earliest time instance.

At block 509b, the system 101 may be configured to compare the ground truth data with a piece of observation data, of the plurality of pieces of observation data, associated with the determined observation to obtain a comparison result. For instance, the system 101 may compare the status data included in the piece of observation data with the map status data included in the ground truth data to obtain the comparison result. The comparison result may include one of four results (e.g., a true positive result, a false positive result, a true negative result, or a false negative result). For instance, the comparison result may correspond to the true positive result if both the status data and the map status data indicates the presence state for the road object. The comparison result may correspond to the false positive result if the status data indicates the presence state for the road object and the map status data indicates the absence state for the road object. The comparison result may correspond to the true negative result if both the status data and the map status data indicates the absence state for the road object. The comparison result may correspond to the false negative result if the status data indicates the absence state for the road object and the map status data indicates the presence state for the road object.

At block 509c, the system 101 may be configured to generate a classification matrix for the determined observation based on the comparison result and past comparison results. For instance, the system 101 may generate a 2×2 classification matrix for the determined observation as illustrated in FIG. 5C.

FIG. 5C illustrates a conceptual diagram showing a classification matrix 500C, in accordance with one or more example embodiments. As is illustrated in FIG. 5C, the classification matrix 500C may be a confusion matrix that includes a plurality of elements 517a-517d. Hereinafter, the term classification matrix and confusion matrix are used interchangeably. Each element of plurality of elements 517a-517d may correspond an observation feature of the plurality of observation features. Each element of the plurality of elements 517a-517d may indicate a count of the corresponding observation feature of the plurality of observation features. For instance, an element 517a of the plurality of elements 517a-517d may indicate a count of the true positive observation feature, an element 517b of the plurality of elements 517a-517d may indicate a count of the false positive observation feature, an element 517c of the plurality of elements 517a-517d may indicate a count of the false negative observation feature, and an element 517d of the plurality of elements 517a-517d may indicate a count of the true negative observation feature. Further, the classification matrix 500C include a first column, including the elements 517a and 517b, that corresponds to the set of positive observation features and a second column, including the elements 517c and 517d, that corresponds to the set of negative observation features. In various embodiments, the system 101 may be configured to increase, based on the comparison result and the past comparison results, the count of at least one observation feature of the plurality of observation features. In an embodiment, the past comparison results may be a null set for the observation associated with the earliest time instance. According to this embodiment, if the comparison result corresponds to the false negative result, the system 101 may be configured to increase the count of the false negative observation feature from zero to one.

Returning to FIG. 5B, the system 101 may be configured to check whether the classification matrix for each observation of the plurality of observations is generated, at block 509d. In other words, the system 101 may be configured to determine whether the classification matrix is generated for all observations. In a case where it is determined that the classification matrix for each observation of the plurality of observations is generated, the system 101 may end the process 500B and return the control to step 509 of FIG. 5A.

In a case where it is determined the classification matrix for each observation of the plurality of observations is not generated, the system 101 may proceed with block 509e. At block 509e, the system 101 may be configured to select a new observation from the plurality of observations. For instance, the system 101 may select, from the plurality of observations, the new observation that is associated with next earliest time instance. The selection of the new observation is based on the time-stamp data of each observation of the plurality of observations. In a case where the plurality of observations includes two or more new observations associated with the same next earliest time instance, then the system 101 may use scheduling algorithm (e.g., a first come, first served (FCFS) algorithm or the like) to select the new observation among the two or more new observations. Further, the system 101 may proceed with block 509b.

At block 509b, the system 101 may be configured to compare the ground truth data with a piece of observation data, of the plurality of pieces of observation data, associated with the new observation to obtain a current comparison result. At block 509c, the system 101 may be configured to generate a new classification matrix for the selected new observation based on the current comparison result and the past comparison results. In an embodiment, the past comparison results for the selected new observation may include the comparison result of the observation associated with the earliest time instance. For instance, the system 101 may generate a new 2×2 classification matrix for the selected new observation as described in the detailed description of FIG. 5C.

In this way, the system may iteratively execute the blocks 509b-509d or 509b-509e to classify, as one of plurality of observation features, each observation of the plurality of observations by generating the classification matrix for each observation of the plurality of observations.

Returning to FIG. 5A, in some embodiments, when the plurality of observations corresponds to a plurality of negative observations, the system 101 may be configured to classify the plurality of observations based on the meta data (at block 509). For instance, the system 101 may classify, based on the meta data included in the plurality pieces of observation data, each negative observation of the plurality of negative observations as one of the true negative observation feature or the false negative observation feature. For instance, if the environmental data of the meta data indicates a foggy environment and the occlusion data of the meta data indicates the vehicle 501 was surrounded by other vehicles, then the system 101 may classify a negative observation of the plurality of negative observation as the false negative observation feature. Conversely, if the environmental data indicates a sunny environment and the occlusion data indicates the vehicle 501 was not surrounded by other vehicles, then the system 101 may classify the negative observation as the true negative observation feature.

At block 511 of the update process framework 503, the system 101 may be configured to determine a generalized probability distribution for the plurality of observations based on the classification of each observation of the plurality of observations. In an embodiment, the determined generalized probability distribution may include a set of probability values for a set of observations of the plurality of observations. For instance, the determination of the generalized probability distribution is as explained in the detailed description of FIG. 5D.

FIG. 5D illustrates a flowchart showing a process 500D for determining the generalized probability distribution for the plurality of observations, in accordance with one or more example embodiments. In an embodiment, the system 101 may be configured to execute the process 500D for determining the generalized probability distribution for the plurality of observations.

At block 511a, the system 101 may be configured to normalize the classification matrix of each observation of the plurality of observations to obtain a normalized classification matrix of a corresponding observation of the plurality of observations. In an embodiment, to obtain a normalized classification matrix of an observation of the plurality of observations, the system 101 may be configured to divide a value of each element of the classification matrix of the observation by a total count of the plurality of observations.

At block 511b, the system 101 may be configured to determine an individual probability distribution for each observation of the plurality of observations based on the obtained normalized classification matrix of the corresponding observation of the plurality of observations. In a first embodiment, the system 101 may extract, as the individual probability distribution of each observation of the plurality of observations, a first column of the obtained normalized classification matrix of the corresponding observation of the plurality of observations. In this first embodiment, the individual probability distribution of an observation of the plurality of observations may include a set of normalized values of the first column of the normalized classification matrix of the observation. In a second embodiment, the system 101 may extract, as the individual probability distribution of each observation of the plurality of observations, a second column of the obtained normalized classification matrix of the corresponding observation of the plurality of observations. In this second embodiment, the individual probability distribution of an observation of the plurality of observations may include a set of normalized values of the second column of the normalized classification matrix of the observation. According to some embodiments, the extraction of one of the first column or the second column may be based on a user selection received by the system 101. For instance, the user selection may be associated with a user (e.g., a map developer).

At block 511c, the system 101 may be configured to determine the generalized probability distribution for the plurality of observations based on the individual probability distribution of each observation of the plurality of observations. In an embodiment, to determine the generalized probability distribution, the system 101 may be configured to determine a Hadamard product of the individual probability distribution of each observation of the plurality of observations. Further, the system 101 may determine a dot product of the individual probability distribution of each observation of the plurality of observations. Furthermore, the system 101 may determine, as the generalized probability distribution, a ratio of the Hadamard product to the dot product. For instance, when the plurality of observations corresponds to a pair of observations, the system 101 may determine the generalized probability distribution as shown in the following equation:

$$γ = \frac{{γ}^{( 1 )} ⊙ {γ}^{( 2 )}}{{γ}^{( 1 )} \cdot {γ}^{( 2 )}} \qquad ( 1 )$$

where ‘γ’ corresponds to the generalized probability distribution, γ⁽¹⁾ corresponds to a first observation of the plurality of observations, and γ⁽²⁾ corresponds to a second observation of the plurality of observations.

In another embodiment, when the total count of the plurality of observations is greater than two, the system 101 may determine the generalized probability distribution as shown in the following equation:

$$γ = \frac{{γ}^{( 1 )} ⊙ {γ}^{( 2 )} ⊙ … ⊙ {γ}^{( m )}}{j \cdot ( {γ}^{( 1 )} ⊙ {γ}^{( 2 )} ⊙ … ⊙ {γ}^{( m )} )} \qquad ( 2 )$$

where j is an m element all-ones rows×column matrix (e.g., m×1 matrix, where each element of the m elements is one), ‘γ’ corresponds to the generalized probability distribution, and γ⁽¹⁾, γ⁽²⁾, . . . , γ^{(m)} correspond to the plurality of observations. In various embodiments, the generalized probability distribution, determined by the equation (1) or (2), includes the set of probability values for one of the set of positive observation features or the set of negative observation features based on the selection of one of the first column or the second column.

Returning to FIG. 5A, at block 513 of the update process framework 503, the system 101 may be configured to determine a confidence score for the plurality of observations based on the determined generalized probability distribution. In an embodiment, the system 101 may determine, as the confidence score, a maximum probability value among the set of probability values included in the determined generalized probability distribution. In essence, the confidence score indicates the likelihood of one of existence (new or still there) or non-existence (removal) of the road object.

At block 515 of the update process framework 503, the system 101 may be configured to determine updated status data for the road object (e.g., the road object 407) based on the confidence score and the ground truth data associated with the road object. In an embodiment, to determine the updated status data, the system 101 may be configured to determine whether the confidence score is greater than a threshold confidence score. In a case where the confidence score is greater than the threshold confidence score, the system 101 may determine, as the updated status data of the road object, a state that is opposite to the map status included in the ground truth data. In case where the confidence score is not greater than the threshold confidence score, the system 101 may determine, as the updated status data of the road object, the map status included in the ground truth data. Further, the system 101 may be configured to update the map database 103a based on the updated status data. For instance, the system 101 may update the map data (specifically, the ground truth data) of the map database 103a to indicate the updated status data.

In this way, the system 101 may be configured to update the map data of the map database 103a by processing the plurality of observations. The updated map data may accurately correspond with the real-world environments. Further, in some embodiments, the system 101 may be configured to generate, using the updated map data, navigation instructions (or control signal(s)) for vehicles (such as vehicle 401) to provide navigation functions such as providing vehicle speed guidance, vehicle speed handling and/or control, providing a route for navigation (e.g., via a user interface), localization, route determination, lane level speed determination, operating the vehicle along a lane level route, lane maintenance, route guidance, provision of traffic information/data, provision of lane level traffic information/data, vehicle trajectory determination and/or guidance, route and/or maneuver visualization, and/or the like.

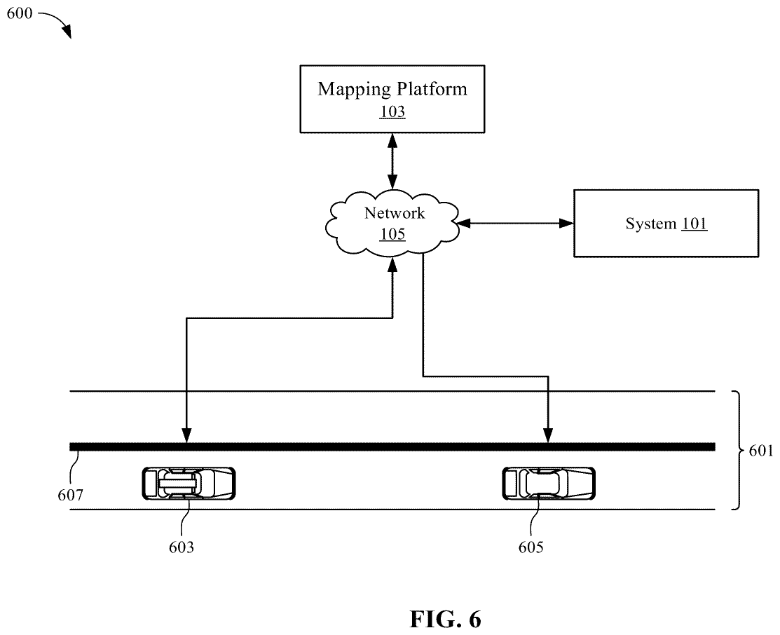

FIG. 6 illustrates a conceptual diagram showing a working environment 600 of the system 101 for updating the map data, in accordance with one or more example embodiments. The working environment 600 includes a link 601 comprising an object 607 (e.g., a road divider). Two vehicles, a vehicle 603 and 605 may traverse a route that includes the road link 601. In some example embodiments, the two vehicles 603 and 605 may not be traversing the route at the same time. Each of the two vehicles 603 and 605, may correspond to any one of an autonomous vehicle, a semi-autonomous vehicle, or a fully manually driven vehicle. As used herein, the autonomous vehicle may be a vehicle that is capable of sensing its environment and operating without human involvement. For instance, the autonomous vehicle may be a self-driving car and the like. As used herein, the vehicle may include a motor vehicle, a non-motor vehicle, an automobile, a car, a scooter, a truck, a van, a bus, a motorcycle, a bicycle, a Segway, and/or the like.

In some example embodiments, the vehicle 605 may be a probe vehicle or a user vehicle capable of performing capture and collection of observations pertaining to objects within the surroundings of the vehicle. In some example embodiments, the vehicle 605 may be a dedicated vehicle for gathering data for development of the map data in the database 103a. In this regard, the vehicle may be equipped with a plurality of sensors such as a camera, a LiDAR sensor, an acceleration sensor (i.e., accelerometer), a gyroscope, a RADAR sensor, an RFID sensor, a GNSS (e.g., a GPS), a wheel odometry, and the like. Using any or a combination of the plurality of sensors, the vehicle 605 may be configured to obtain sensor data associated with detection of the object 607. This data may be referred to as observation data.

In some example embodiments, the vehicle 603 may be a passenger vehicle for carrying passengers or cargo. Navigation control of the vehicle 603 may be based on data and/or instructions provided by the mapping platform 103. In this regard, the vehicle may be equipped with equipment/circuitry configured to execute and run applications/programs such as a navigation application. Thus, the vehicle 603 may at least serve as a beneficiary of the map data provided by the mapping platform 103.

Vehicle 605 may transmit the observation data to the mapping platform 103, via the network 105. The observation data may be transmitted in any suitable manner such as sequentially or as batch uploads. Upon receipt of the observation data, the mapping platform 103 may invoke the system 101, which may be an on-premises or cloud-based system, and thus may be integrated within the mapping platform 103 or connected to the mapping platform 103 via the network 105. In either case, the system 101 comprises one or more processors and associated circuitry for processing the observation data.

The system 101 may execute the process for updating the map data to indicate the object 607 in a manner similar to the ones described with reference to FIGS. 5A-5D. The system 101 may be configured to read as well as write data in the map database 103a of the mapping platform 103. In some example embodiments, the system 101 may send control instructions to the mapping platform 103 to update the data in the map database 103a. As a result of the update of map data in the map database 103a, the map database 103a is validated for any inaccuracy with respect to the object 607 in the map. The updated map data may be provided to user equipment serving as beneficiaries in any suitable manner such as on request or through a push update mechanism.

In some example embodiments, vehicle 603 may request for navigation assistance from the mapping platform 103. In some example embodiments, vehicle 603 may request for the map data of the region and perform navigation assistance by itself. In some other embodiments, the vehicle 603 may not request the map data but may receive the updated map data through a push mechanism and maintain a local cache of it. In either case, the vehicle 603 benefits from the updated map data by generating precise navigation assistance. Some non-limiting examples of the navigation related services include providing vehicle speed guidance, vehicle speed handling and/or control, providing a route for navigation (e.g., via a user interface), localization, route determination, lane level speed determination, operating the vehicle along a lane level route, route travel time determination, lane maintenance, route guidance, provision of traffic information/data, provision of lane level traffic information/data, vehicle trajectory determination and/or guidance, route and/or maneuver visualization, and/or the like.

In some embodiments, one or both of the vehicles 603 and/or 605, may themselves include the system 101 for performing the map data update processing. Further, the number of vehicles in FIG. 6 is shown to be two only for the purpose of brevity of explanation. However, in practical implementation, it may be contemplated that any number of vehicles may be used without deviating from the scope of the present disclosure.

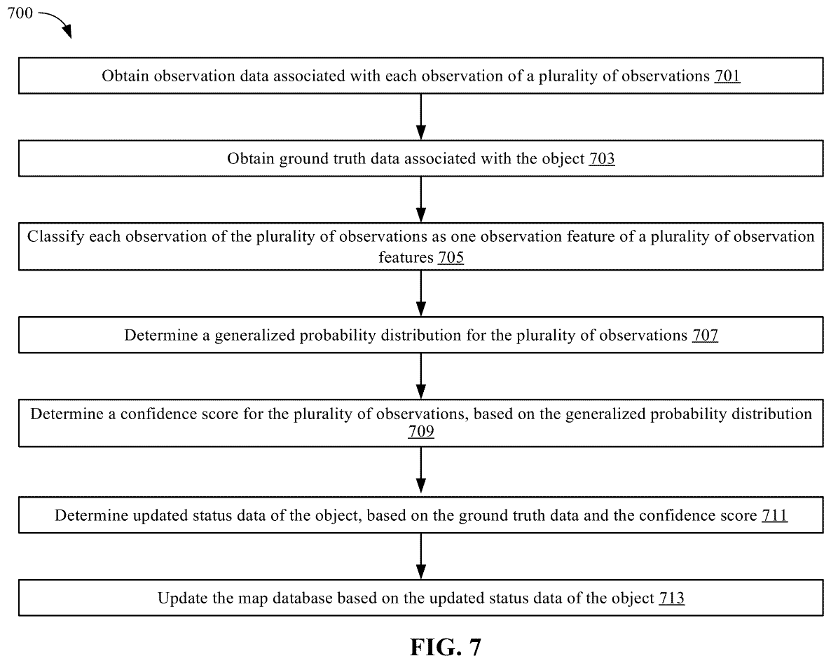

FIG. 7 illustrates a flowchart showing a method 700 for updating the map database 103a, in accordance with one or more example embodiments. It will be understood that each block of the flow diagram of the method 700 a may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by the memory 203 of the system 101, employing an embodiment of the present invention and executed by the processor 201. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram 700 may support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

At block 701, the method 700 may include obtaining the observation data associated with each observation of the plurality of observations. For instance, the system 101 may receive the plurality of observations associated with the object. In various embodiments, the plurality of observations may be received from heterogeneous dissimilar observation systems (such as multiple probe vehicles). Additionally, each observation system of the heterogeneous dissimilar observation systems may report an individual probability distribution for a corresponding observation of the plurality of observations while reporting the corresponding observation. Further, the system 101 may obtain the observation data associated with each observation of the plurality of observations as explained in the detailed description of FIG. 5A.

At block 703, the method 700 may include obtaining the ground truth data associated with the object. For instance, the system 101 may obtain, from the map database 103a, the ground truth data associated with the object. In various embodiments, the ground truth data indicates one of the presence of the object in the map data of the map database 103a or the absence of the object in the map data of the map database 103a.

At block 705, the method 700 may include classifying each observation of the plurality of observations as one observation feature of the plurality of observation features, based on the observation data of a corresponding observation of the plurality of observations and the ground truth data. For instance, the system 101 may classify each observation of the plurality of observations as one observation feature of the plurality of observation features as explained in the detailed description of FIG. 5A-FIG. 5C. In various embodiments, the plurality of observation features may include two or more of the true positive observation features, the false positive observation feature, the true negative observation feature, or the false negative observation feature.

At block 707, the method 700 may include determining the generalized probability distribution for the plurality of observations, based on the classification of each observation of the plurality of observations. For instance, the system 101 may determine the generalized probability distribution as explained in the detailed description of FIG. 5A and FIG. 5D. In various embodiments, the generalized probability distribution may include the set of probability values for the set of observations of the plurality of observations.

At block 709, the method 700 may include determining a confidence score for the plurality of observations based on the generalized probability distribution. In various embodiments, the determined confidence score may correspond to a maximum probability value of the set of probability values included in the generalized probability distribution.

At block 711, the method 700 may include determining the updated status data of the object based on the ground truth data and the confidence score. For instance, the system 101 may determine the updated status data of the object as explained in the detailed description of FIG. 5A. At block 713, the method 700 may include updating the map database 103a based on the updated status data of the object. In various embodiments, the system 101 may update the map data of the map database 103a to indicate the updated status data.

Additionally, or alternatively, the method 700 may include a step of generating, using the updated map data, one or more navigation instructions for a vehicle to provide one or more navigation functions. In various embodiments, the one or more navigation functions may include providing vehicle speed guidance, vehicle speed handling and/or control, providing a route for navigation (e.g., via a user interface), localization, route determination, lane level speed determination, operating the vehicle along a lane level route, lane maintenance, route guidance, provision of traffic information/data, provision of lane level traffic information/data, vehicle trajectory determination and/or guidance, route and/or maneuver visualization, and/or the like.

In this way, the method 700 may receive the plurality of observations from the heterogeneous dissimilar observation systems and rigorously combine the plurality of observations to determine the generalized probability distribution for the object. Further, the method 700 may determine the confidence score using the generalized probability distribution and update the map data based on the confidence score.

Therefore, in accordance with various embodiments of the present disclosure, the map data in a map database may be updated in an efficient manner such that the updated map data corresponds to a ‘true’ or ‘near true’ reflection of a dynamically changing real-world environment. Enabled with such an improved and updated map database, end use devices and systems such as navigation systems that utilize the map database for generating routing instructions benefit from the improved accuracy and are thus capable of generating accurate navigation control instructions. In this way, embodiments of the present disclosure provide measures and techniques to mitigate inaccuracies of navigation systems, thereby reducing potentially dangerous maneuvers that could otherwise lead to accidents or collisions of the vehicles utilizing the map data of the map database. Thus, several embodiments of the disclosure find applications in the real world while providing technical improvements in the field of mapping and navigation technology as well as vehicle safety.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A system, comprising:
a memory configured to store computer-executable instructions; and
a processor configured to execute the computer-executable instructions to:
obtain observation data associated with each observation of a plurality of observations, wherein the plurality of observations is associated with an object;
obtain ground truth data associated with the object, wherein the ground truth data indicates one of a presence of the object in map data of a map database, or an absence of the object in map data of the map database;
classify each observation of the plurality of observations as one observation feature of a plurality of observation features, based on the observation data of a corresponding observation of the plurality of observations and the ground truth data;
determine a generalized probability distribution for the plurality of observations, based on the classification of each observation of the plurality of observations, wherein the generalized probability distribution includes a set of probability values for a set of observation features of the plurality of observation features;
determine a confidence score for the plurality of observations based on the generalized probability distribution;
determine updated status data of the object, based on the ground truth data and the confidence score; and
update the map database based on the updated status data of the object.

2. The system of claim 1, wherein to classify each observation of the plurality of observations, the processor is configured to:
compare the observation data associated with each observation of the plurality of observations with the ground truth data to obtain a corresponding result; and
generate, based on the corresponding result, a classification matrix for each corresponding observation of the plurality of observations, wherein each element of the classification matrix corresponds to an observation feature of the plurality of observation features.

3. The system of claim 2, wherein to determine the generalized probability distribution, the processor is configured to:
determine an individual probability distribution for each observation of the plurality of observations, based on the classification matrix of a corresponding observation of the plurality of observations; and
generate the generalized probability distribution, based on the individual probability distribution of each observation of the plurality of observations.

4. The system of claim 3,
wherein the classification matrix of a first observation of the plurality of observations includes a first column corresponding to a set of positive observation features of the plurality of observation features and a second column corresponding to a set of negative observation features of the plurality of observation features,
wherein to determine the individual probability distribution for the first observation, the processor is configured to:
normalize the classification matrix of the first observation to obtain a normalized classification matrix; and
generate the individual probability distribution of the first observation based on one of the first column of the normalized classification matrix or the second column of the normalized classification matrix, and
wherein the set of observation features corresponds to one of the set of positive observation features or the set of negative observation features.

5. The system of claim 4, wherein
the set of positive observation features includes at least one of a true positive observation feature or a false positive observation feature, and
the set of negative observation features includes at least one of a true negative observation feature or a false negative observation feature.

6. The system of claim 3, wherein the plurality of observations corresponds to a pair of observations and to generate the generalized probability distribution, the processor is configured to:
determine a Hadamard product of the individual probability distribution of each observation of the pair of observations;
determine a dot product of the individual probability distribution of each observation of the pair of observations; and
generate the generalized probability distribution based on the Hadamard product and the dot product.

7. The system of claim 3, wherein to generate the generalized probability distribution, the processor is further configured to:
determine a Hadamard product of the individual probability distribution of each observation of the plurality of observations; and
generate the generalized probability distribution based on an all-ones column matrix and the determined Hadamard product.

8. The system of claim 2,
wherein the plurality of observations includes a first observation associated with a first-time instance and a second observation associated with a second-time instance subsequent to the first-time instance, and
wherein the processor is configured to:
generate a first classification matrix for the first observation, based on the corresponding result of the first observation; and
generate a second classification matrix for the second observation based on the corresponding result of the first observation and the corresponding result of the second observation.

9. The system of claim 1, wherein the confidence score corresponds to a maximum probability value among the set of probability values.

10. The system of claim 2, wherein the observation data associated with a first observation of the plurality of observations includes at least one of: object type information of the object, location information of the object, identity information of the object, time-stamp data of the first observation, or metadata associated with the first observation.

11. The system of claim 10,
wherein the metadata associated with the first observation includes at least one of environmental data associated with the first observation or occlusion data associated with the first observation, and
wherein the processor is configured to classify the first observation as a first observation feature of the plurality of observation features, based on the metadata associated with the first observation.

12. A computer-implemented method for updating a map database, the method comprising:
obtaining observation data associated with each observation of a plurality of observations associated with an object;
obtaining ground truth data associated with the object, wherein the ground truth data indicates one of a presence of the object in map data of the map database, or an absence of the object in map data of the map database;
classifying each observation of the plurality of observations as one observation feature of a plurality of observation features, based on the observation data of a corresponding observation of the plurality of observations and the ground truth data;
determining a generalized probability distribution for the plurality of observations, based on the classification of each observation of the plurality of observations, wherein the generalized probability distribution includes a set of probability values for a set of observation features of the plurality of observation features;
determining a confidence score for the plurality of observations, based on the generalized probability distribution;
determining updated status data of the object, based on the ground truth data and the confidence score; and
updating the map database based on the updated status data of the object.

13. The method of claim 12, wherein classifying each observation of the plurality of observations comprises:
comparing the observation data associated with each observation of the plurality of observations with the ground truth data to obtain a corresponding result; and
generating, based on the corresponding result, a classification matrix for each corresponding observation of the plurality of observations, wherein each element of the classification matrix corresponds to an observation feature of the plurality of observation features.

14. The method of claim 13, wherein determining the generalized probability distribution comprises:
determining an individual probability distribution for each observation of the plurality of observations, based on the classification matrix of a corresponding observation of the plurality of observations; and
generating the generalized probability distribution, based on the individual probability distribution of each observation of the plurality of observations.

15. The method of claim 14,
wherein the classification matrix of a first observation of the plurality of observations includes a first column corresponding to a set of positive observation features of the plurality of observation features and a second column corresponding to a set of negative observation features of the plurality of observation features,
wherein determining the individual probability distribution for the first observation comprises:
normalizing the classification matrix of the first observation to obtain a normalized classification matrix; and
generating the individual probability distribution of the first observation based on one of the first column of the normalized classification matrix or the second column of the normalized classification matrix, and
wherein the set of observation features corresponds to one of the set of positive observation features or the set of negative observation features.

16. The method of claim 15, wherein
the set of positive observation features includes at least one of a true positive observation feature or a false positive observation feature, and
the set of negative observation features includes at least one of a true negative observation feature or a false negative observation feature.

17. The method of claim 14, wherein the plurality of observations corresponds to a pair of observations and for generating the generalized probability distribution, the method comprises:
determining a Hadamard product of the individual probability distribution of each observation of the pair of observations;
determining a dot product of the individual probability distribution of each observation of the pair of observations; and
generating the generalized probability distribution based on the Hadamard product and the dot product.

18. The method of claim 14, wherein generating the generalized probability distribution comprises:
determining a Hadamard product of the individual probability distribution of each observation of the plurality of observations; and
generating the generalized probability distribution based on an all-ones column matrix and the determined Hadamard product.

19. The method of claim 13,
wherein the plurality of observations includes a first observation associated with a first-time instance and a second observation associated with a second-time instance subsequent to the first-time instance, and
wherein generating the classification matrix for each corresponding observation of the plurality of observations comprises:
generating a first classification matrix for the first observation, based on the corresponding result of the first observation; and
generating a second classification matrix for the second observation based on the corresponding result of the first observation and the corresponding result of the second observation.

20. A computer program product comprising at least one non-transitory computer-readable storage medium having stored thereon computer-executable instructions which when executed by a computer, cause the computer to carry out operations for updating a map database, the operations comprising:
obtaining observation data associated with each observation of a plurality of observations associated with an object;
obtaining ground truth data associated with the object, wherein the ground truth data indicates one of a presence of the object in map data of the map database, or an absence of the object in map data of the map database;
classifying each observation of the plurality of observations as one observation feature of a plurality of observation features, based on the observation data of a corresponding observation of the plurality of observations and the ground truth data;
determining a generalized probability distribution for the plurality of observations, based on the classification of each observation of the plurality of observations, wherein the generalized probability distribution includes a set of probability values for a set of observation features of the plurality of observation features;
determining a confidence score for the plurality of observations, based on the generalized probability distribution;
determining updated status data of the object, based on the ground truth data and the confidence score; and
updating the map database based on the updated status data of the object.
